(19) United States
(12) Patent Application Publication
(10) Pub. No.: US 2025/0170699 A1
(43) Pub. Date: May 29, 2025

(54) Torch Holder

(71) Applicant: Donald Henry Coates, Camas, WA (US)

(72) Inventor: Donald Henry Coates, Camas, WA (US)

(21) Appl. No.: 18/936,612

(22) Filed: Nov. 4, 2024

Related U.S. Application Data
(60) Provisional application No. 63/603,713, filed on Nov. 29, 2023.

(51) Int. Cl. B25H 1/00; F16M 13/02

(52) U.S. Cl. CPC B25H 1/0042; F16M 13/022; F16M 2200/06

(57) ABSTRACT

A universal torch holder for use with portable gas torches. The torch holder comprises a receiver, a stabilizing arm, and a retaining hook. The receiver secures around the neck of the gas torch. The retaining hook is used to hang the gas torch to a nearby structure or object, while the stabilizing arm extends the gas torch away from said structure or object. The torch holder can be constructed either from bent wire or bent sheet metal. The structure or object can include any suitable item conveniently within reach of the user such as a vehicle, a ladder, or tool belt. During use, the torch holder allows the user to safely hang the gas torch to the structure or object while performing a task. This arrangement keeps the gas torch secured in an upright position, preventing the gas torch from being tipped over and rolling around when not in use.

### FIELD OF THE INVENTION

The present invention relates generally to torch accessories. More specifically, the present invention is a torch holder that secures a gas torch in an upright position.

### BACKGROUND OF THE INVENTION

A propane torch holder serves as a practical accessory, enhancing safety and convenience during the use of a propane torch. It offers stability, preventing the torch from tipping over during tasks like soldering or weed control. With the holder, users can achieve hands-free operation, allowing them to focus on tasks requiring both hands or for extended periods. Many holders feature adjustable angles to direct the flame precisely. Some are equipped with heat shields to protect surrounding surfaces. Certain holders are designed for mobility, incorporating wheels or a portable base. Additionally, holders provide a designated storage space for the torch, contributing to workspace organization and reducing the risk of damage. Constructed from durable materials, propane torch holders withstand the heat generated during torch operation, ensuring long-lasting support. Overall, these holders are valuable tools for individuals engaged in tasks that necessitate the use of a propane torch, contributing to safety, efficiency, and convenience.

An objective of the present invention is to provide users with a torch holder, to help secure a propane torch. The present invention intends to provide users with a device that prevents the user from having to set the torch down during use. In order to accomplish that, a preferred embodiment of the present invention comprises a receiver, a stabilizing arm, and a retaining hook. Thus, the present invention is a torch holder that secures a propane torch upright to an external object during a task.

### SUMMARY OF THE INVENTION

The present invention is a universal torch holder for use with portable gas torches. The torch holder comprises a receiver, a stabilizing arm, and a retaining hook. The receiver secures around the neck of the gas torch, thereby holding the gas torch in the upright position. The retaining hook is used to hang the gas torch to a nearby structure or object, while the stabilizing arm extends the gas torch away from said structure or object. The structure or object can include any suitable item conveniently within reach of the user such as a vehicle, a ladder, or tool belt. During use, the torch holder allows the user to safely hang the gas torch to the structure or object while performing a task. This keeps the gas torch secured in an upright position, preventing the gas torch from being tipped over and rolling around when not in use.

In the preferred embodiment, the torch holder is constructed from bent metal wire. In this embodiment, the receiver is in the form of an open loop that fits around the neck of the gas torch. The stabilizing arm and the retaining hook are in the form of a pair of struts. The struts on the stabilizing arm have a narrow section that integrates with the open loop. The narrow section is configured to have an interference fit, requiring the user to press the neck of the gas torch through the narrow section and into the loop.

In another embodiment, the torch holder is constructed from bent sheet metal. In this embodiment, the receiver is in the form of an opening that traverses through a receiver flange. The opening fits around the neck of the gas torch. The receiver flange integrates with the retaining hook which is in the form of a mounting bracket.

### BRIEF DESCRIPTION OF THE DRAWINGS

FIG. 1 is a top-front perspective view of the present invention, shown in a state of use.

FIG. 2 is a front elevational view of the present invention, shown in a state of use.

FIG. 3 is a top-front perspective view of the present invention.

FIG. 4 is a front elevational view of the present invention.

FIG. 5 is a left-side elevational view of the present invention.

FIG. 6 is a top plan view of the present invention.

FIG. 7 is a top-front perspective view of an alternative embodiment of the present invention.

FIG. 8 is a front elevational view of the alternative embodiment of the present invention.

FIG. 9 is a top plan view of the alternative embodiment of the present invention.

### DETAIL DESCRIPTIONS OF THE INVENTION

All illustrations of the drawings are for the purpose of describing selected versions of the present invention and are not intended to limit the scope of the present invention.

Hereinafter, the term “strut” is given its plain and ordinary meaning defined as a structural member that provides outward-facing support along the length-wise direction, which can be used to keep two other components separate.

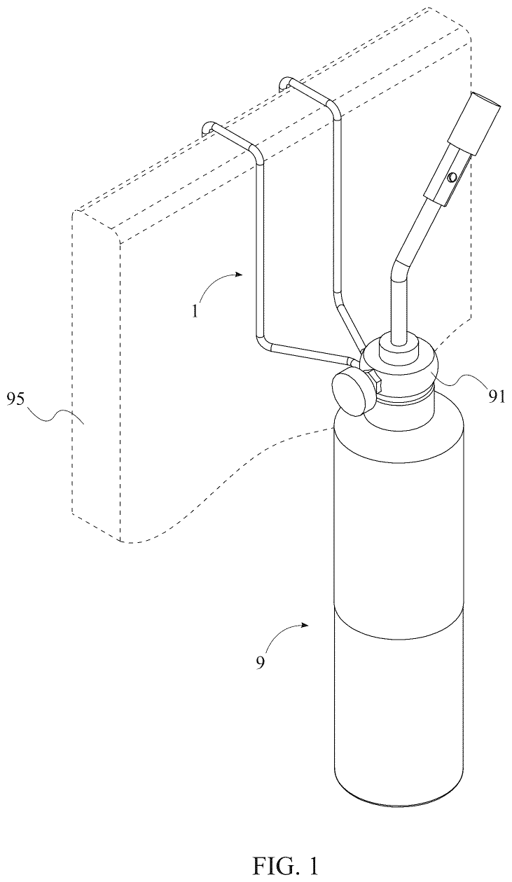

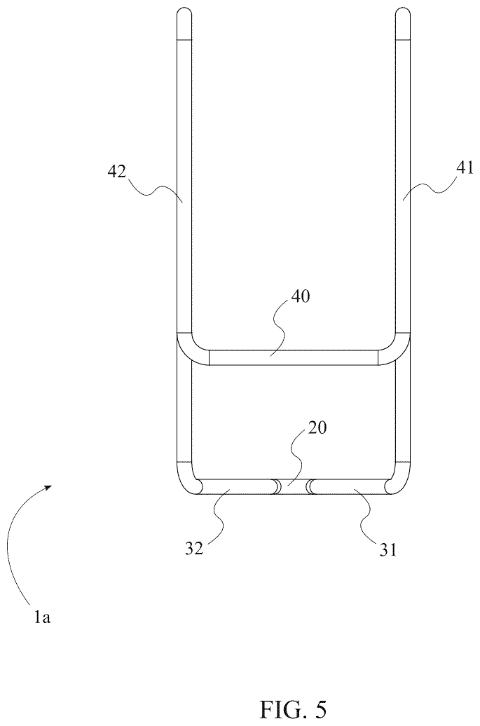

In reference to FIGS. 1-9, the present invention is a universal torch holder 1. The torch holder 1 fits onto a portable gas torch 9, allowing the user to safely hang the gas torch to any suitable structure or object 95 while in the upright position. Due to their cylindrical shape, gas torches are prone to tipping over and rolling around if left unattended or otherwise not properly secured. Keeping the gas torch upright and secure is especially important for fire safety reasons, namely, to prevent the gas torch from tipping over and causing a fire hazard.

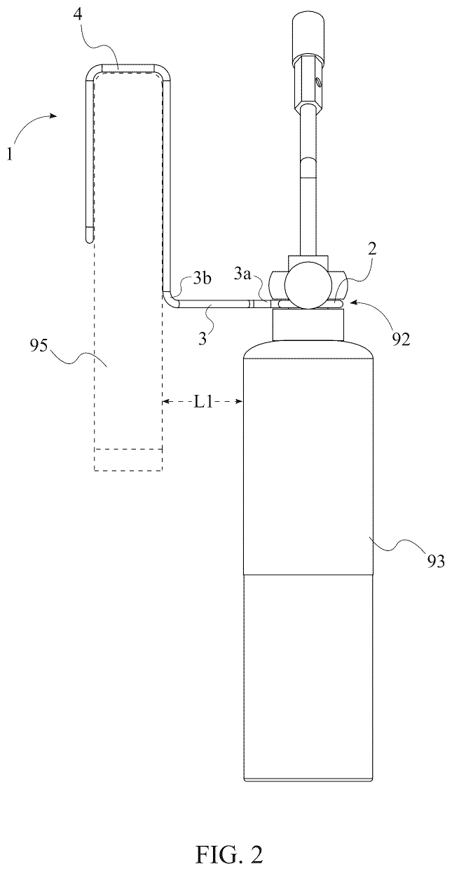

To accomplish this objective, the torch holder 1 comprises a receiver 2, a stabilizing arm 3, and a retaining hook 4. As best seen in FIG. 2, the stabilizing arm 3 connects the receiver 2 to the retaining hook 4. Specifically, a first end 3a of the stabilizing arm is terminally connected to the receiver 2, while the second end 3b of the stabilizing arm is terminally connected to the retaining hook 4. The retaining hook 4 extends outward from the stabilizing arm 3, facing opposite of the receiver 2. The receiver 2 is configured to detachably connect to the neck 92 of the gas torch 9. The retaining hook 4 is configured to slidably engage with and detachably connect to a structure or object 95. Such structures and/or objects can include but are not limited to ladders, work vehicles, and tool belts.

The stabilizing arm 3 functions as a horizontal stiffener, providing structural support to hold the gas torch 9 in an upright position even while loaded. A length of the stabilizing arm 3 measured from the first end 3a to the second end 3b is predefined, delineated by the size and type of gas torch being used. In this arrangement, the stabilizing arm 3 offsets the gas torch 9 away from the structure 95 by a predefined distance L1. Providing adequate distance between the gas torch 9 and the structure 95 helps improve ergonomics as well as safety. Specifically, the predefined distance L1 prevents the gas torch 9 from impacting the structure or object 95 while in motion.

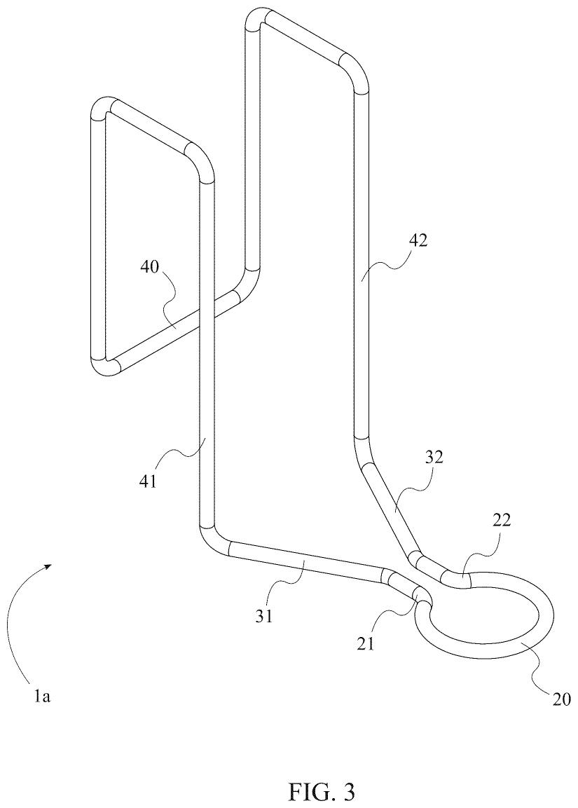

In a preferred embodiment, as seen in FIGS. 3-6, the torch holder 1a is constructed from bent steel wire. It is understood that the material selection of the bent wire is not limited to steel and can include any other suitable material based on design, user, and or manufacturing requirements. In this embodiment, the receiver 2 is in the form of an open loop 20, the stabilizing arm 3 is in the form of a pair of skewed struts 31,32, and the retaining hook 4 is in the form of a pair of parallel struts 41,42. The open loop 20 is sized to perimetrically surround the neck 92 of the gas torch.

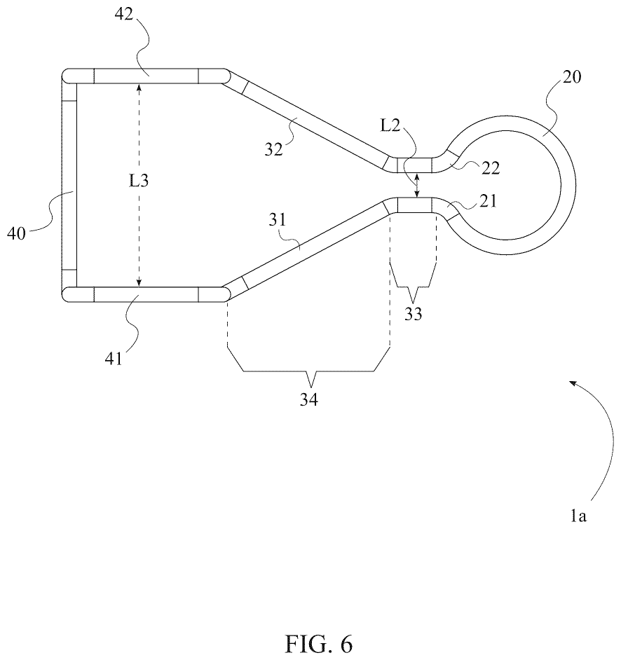

Continuing with the preferred embodiment, the pair of skewed struts 31,32 are elongated members that extend from the open loop 20 and integrate into the pair of parallel struts 41,42. As seen in FIG. 6, the pair of skewed struts 31,32 comprises multiple sections, namely, an interference section 33 and a widening section 34. To attach the gas torch 9 to the torch holder 1a, the user positions the neck 92 of the gas torch within the widening section 34 and then firmly presses the neck 92 through the interference section 33 and into the open loop 20.

At the interference section 33, the ends of the skewed struts 31,32 terminally connect to a pair of corresponding open-end segments 21,22 of the open loop 20. A gap L2 formed between the skewed struts along the interference section 33 is slightly smaller than the neck 92 of the gas torch. This creates a press fit engagement between the neck 92 of the gas torch and the pair of skewed struts 31,32. Once the neck 92 is positioned within the open loop 20, the interference section 33 functions as a locking retainer, preventing the neck 92 from inadvertently sliding in and out of the open loop 20 when no force is applied.

At the widening section 34, the pair of skewed struts 31,32 extends outward from the interference section 33 and terminally connects to the pair of parallel struts 41,42. Due to the widening effect, a gap L3 formed between the pair of parallel struts 41,42 is substantially larger than the gap L2 formed between the pair of skewed struts 31,32 measured along the interference section 33.

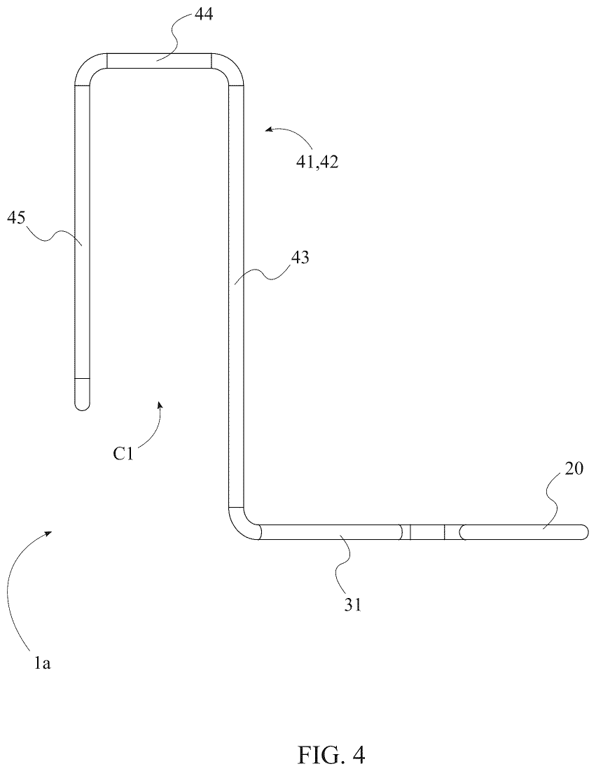

In reference to FIG. 4, the pair of parallel struts 41,42 comprises multiple sections, namely, an inboard section 43, a mounting section 44, and an outboard section 45. The inboard section 43 is terminally connected to the widening section 34, wherein the inboard section 43 is oriented perpendicular to the widening section 34. The inboard section 43 extends upward from the widening section 34 and terminally connects to the mounting section 44. The mounting section 44 extends longitudinally outward, connecting the inboard section 43 to the outboard section 45. The outboard section 45 extends downward from the mounting section 44, wherein the outboard section 45 is oriented substantially parallel with the inboard section 43. Preferably, the pair of parallel struts 41,42 further comprises a lateral segment 40. The lateral segment 40 connects the open ends of each of the pair of parallel struts 41,42 to form an enclosed wire structure. The resulting profile shape of the pair of parallel struts forms a cavity C1. When hanging the retaining hook 4 to a structure 95, the cavity C1 slidably engages with an external portion of the structure 95, thereby allowing the retaining hook 4 to firmly attach to the structure or object 95.

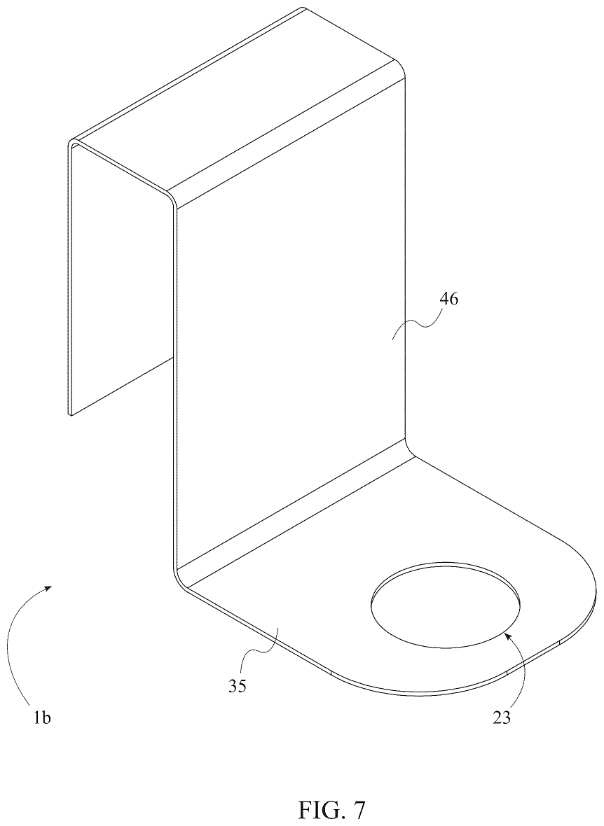

In another embodiment, as seen in FIGS. 7-9, the torch holder 1b is constructed from bent sheet metal made from stamped steel. It is understood that the material selection of the bent sheet metal is not limited to steel and can include any other suitable material based on design, user, and or manufacturing requirements. In this embodiment, the receiver 2 is in the form of an opening 23, the stabilizing arm 3 is in the form of a receiver flange 35, and the retaining hook 4 is in the form of a mounting bracket 46. To use the invention with this embodiment, the user first removes the head 91 of the gas torch 9 from the gas bottle 93. Then, the opening 23 of the torch holder 1b is slipped over the neck 92 of the gas torch and the head 91 is reattached to the gas bottle 93. Once fully assembled, the opening 23 perimetrically surrounds the neck 92 of the gas torch.

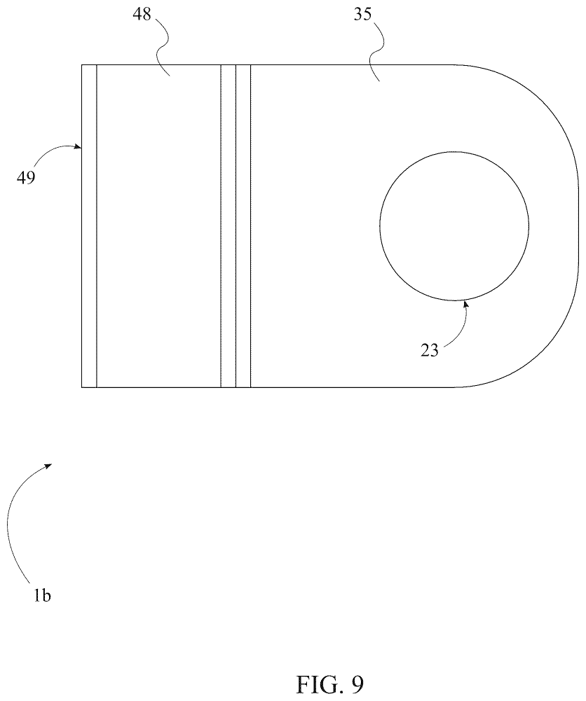

In this embodiment, the receiver flange 35 is an elongated member that terminally connects to the mounting bracket 46. As best seen in FIG. 9, the opening 23 is disposed on the face of the receiver flange 35, wherein the opening 23 is sized to perimetrically surround the neck 92 of the gas torch 9. Preferably, the opening 23 is circular in shape. However, the shape of the opening 23 is not limited and can take the form of any suitable shape based on design, user, and or manufacturing requirements

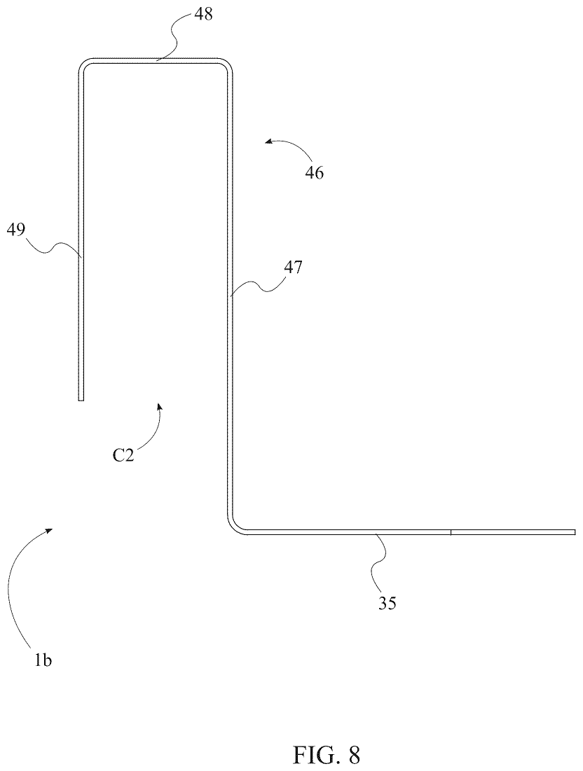

In reference to FIG. 8, the mounting bracket 46 comprises multiple flanges, namely, an inboard flange 47, a mounting flange 48, and an outboard flange 49. The inboard flange 47 is terminally connected to the receiver flange 35, wherein the inboard flange 47 is oriented perpendicular to the receiver flange 35. The inboard flange 47 extends upward from the receiver flange 35 and terminally connects to the mounting flange 48. The mounting flange 48 extends longitudinally outward, connecting the inboard flange 47 to the outboard flange 49. The outboard flange 49 extends downward from the mounting flange 48, wherein the outboard flange 49 is oriented substantially parallel with the inboard flange 47. The resulting profile shape of the mounting bracket 46 forms a cavity C2. When hanging the retaining hook 4 to a structure 95, the cavity C2 slidably engages with an external portion of the structure 95, thereby allowing the retaining hook 4 to firmly attach to the structure or object 95.

What is claimed is:

1. A torch holder for use with a portable gas torch, the torch holder comprising:
a receiver;
a stabilizing arm;
a retaining hook;
a first end of the stabilizing arm being terminally connected to the receiver;
a second end of the stabilizing arm being terminally connected to the retaining hook;
the retaining hook extending outward, facing opposite of the receiver;
the receiver configured to detachably connect to the neck of a gas torch;
the retaining hook configured to slidably engage with and detachably connect to a structure;
the stabilizing arm positioning the gas torch away from the structure by a predefined distance; and
the torch holder capable of securing the gas torch to the structure in an upright position.

2. The torch holder as claimed in claim 1 comprising:
the torch holder being constructed from bent metal wire;
the receiver being in the form of an open loop;
the stabilizing arm being in the form of a pair of skewed struts;
the retaining hook being in the form of a pair of parallel struts; and
the open loop perimetrically surrounding the neck of the gas torch.

3. The torch holder as claimed in claim 2 comprising:
the pair of skewed struts comprising an interference section and a widening section;
the interference section being terminally connected to a pair of open-end segments of the open loop;
the widening section extending outward and integrating with the pair of parallel struts; and
the gap between the pair of parallel struts being larger than the gap between the pair of skewed struts along the interference section.

4. The torch holder as claimed in claim 3 comprising:
the pair of parallel struts comprising an inboard section, a mounting section, and an outboard section;
the inboard section being terminally connected to the widening section;
the inboard section extending upward into the mounting section; and
the mounting section connecting the inboard section to the outboard section.

5. The torch holder as claimed in claim 4 comprising:
the outboard section extending downward, oriented substantially parallel with the inboard section;
the pair of parallel struts having a profile shape in the form of a cavity; and
the cavity being configured to slidably engage with the structure.

6. The torch holder as claimed in claim 5 comprising:
the pair of parallel struts further comprising a lateral segment; and
the lateral segment connecting the open ends of each of the pair of parallel struts, forming an enclosed wire structure.

7. The torch holder as claimed in claim 1 comprising:
the torch holder being constructed from bent sheet metal;
the receiver being in the form of an opening;
the stabilizing arm being in the form of a receiver flange; and
the retaining hook being in the form of a mounting bracket.

8. The torch holder as claimed in claim 7 comprising:
the opening being disposed on the receiver flange; and
the opening perimetrically surrounding the neck of the gas torch.

9. The torch holder as claimed in claim 8 comprising:
the mounting bracket comprising an inboard flange, a mounting flange, and an outboard flange;
the inboard flange being terminally connected to the receiver flange;
the inboard flange extending upward into the mounting flange; and
the mounting flange connecting the inboard flange to the outboard flange.

10. The torch holder as claimed in claim 9 comprising:
the outboard flange extending downward, oriented substantially parallel with the inboard flange;
the mounting bracket having a profile shape in the form of a cavity; and
the cavity being configured to slidably engage with the structure.

11. A torch holder for use with a portable gas torch, the torch holder comprising:
a receiver;
a stabilizing arm;
a retaining hook;
a first end of the stabilizing arm being terminally connected to the receiver;
a second end of the stabilizing arm being terminally connected to the retaining hook;
the retaining hook extending outward, facing opposite of the receiver;
the receiver configured to detachably connect to the neck of a gas torch;
the retaining hook configured to slidably engage with and detachably connect to a structure;
the stabilizing arm positioning the gas torch away from the structure by a predefined distance;
the torch holder capable of securing the gas torch to the structure in an upright position;
the torch holder being constructed from bent metal wire;
the receiver being in the form of an open loop;
the stabilizing arm being in the form of a pair of skewed struts;
the retaining hook being in the form of a pair of parallel struts;
the open loop perimetrically surrounding the neck of the gas torch;
the pair of skewed struts comprising an interference section and a widening section;
the interference section being terminally connected to a pair of open-end segments of the open loop; and
the widening section extending outward and integrating with the pair of parallel struts.

12. The torch holder as claimed in claim 11, wherein the gap between the pair of parallel struts is larger than the gap between the pair of skewed struts along the interference section.

13. The torch holder as claimed in claim 12 comprising:
the pair of parallel struts comprising an inboard section, a mounting section, and an outboard section;
the inboard section being terminally connected to the widening section;
the inboard section extending upward into the mounting section; and
the mounting section connecting the inboard section to the outboard section.

14. The torch holder as claimed in claim 13 comprising:
the outboard section extending downward, oriented substantially parallel with the inboard section;
the pair of parallel struts having a profile shape in the form of a cavity; and
the cavity being configured to slidably engage with the structure.

15. The torch holder as claimed in claim 14 comprising:
the pair of parallel struts further comprising a lateral segment; and
the lateral segment connecting the open ends of each of the pair of parallel struts, forming an enclosed wire structure.

16. A torch holder for use with a portable gas torch, the torch holder comprising:
a receiver;
a stabilizing arm;
a retaining hook;
a first end of the stabilizing arm being terminally connected to the receiver;
a second end of the stabilizing arm being terminally connected to the retaining hook;
the retaining hook extending outward, facing opposite of the receiver;
the receiver configured to detachably connect to the neck of a gas torch;
the retaining hook configured to slidably engage with and detachably connect to a structure;
the stabilizing arm positioning the gas torch away from the structure by a predefined distance;
the torch holder capable of securing the gas torch to the structure in an upright position;
the torch holder being constructed from bent sheet metal;
the receiver being in the form of an opening;
the stabilizing arm being in the form of a receiver flange;
the retaining hook being in the form of a mounting bracket;
the opening being disposed on the receiver flange; and
the opening perimetrically surrounding the neck of the gas torch.

17. The torch holder as claimed in claim 16 comprising:
the mounting bracket comprising an inboard flange, a mounting flange, and an outboard flange;
the inboard flange being terminally connected to the receiver flange;
the inboard flange extending upward into the mounting flange; and
the mounting flange connecting the inboard flange to the outboard flange.

18. The torch holder as claimed in claim 17 comprising:
the outboard flange extending downward, oriented substantially parallel with the inboard flange;
the mounting bracket having a profile shape in the form of a cavity; and
the cavity being configured to slidably engage with the structure.
